(19) United States
(12) Patent Application Publication
(10) Pub. No.: US 2006/0008107 A1
(43) Pub. Date: Jan. 12, 2006

(54) Speaker device

(76) Inventors: Takashi Suzuki, Yamagata-ken (JP); Hiroya Oizumi, Yamagata-ken (JP); Jonathan Scott Owens, Tempe, AZ (US)

Correspondence Address: ARENT FOX PLLC, 1050 CONNECTICUT AVENUE, N.W., SUITE 400, WASHINGTON, DC, 20036, US

(21) Appl. No.: 11/176,675

(22) Filed: Jul. 8, 2005

(30) Foreign Application Priority Data
Jul. 9, 2004 (JP) JP 2004-203620

(51) Int. Cl. H04R 25/00

(52) U.S. Cl. 381/386; 381/395

(57) ABSTRACT

It is an object of the present invention to reduce a playback distortion and make it possible to output a large volume sound in a low frequency area, without increasing the diameter of subwoofer or woofer. A speaker device comprises a speaker unit, a diaphragm of the speaker unit disposed at an opening of a baffle plate, and a compression board disposed opposite to a radiation surface of the diaphragm in a manner such that a predetermined interval is formed between the compression board and the baffle plate.

### BACKGROUND OF THE INVENTION

The present invention relates to a speaker device.

The present application claims priority from Japanese Applications No. 2004-203620, the disclosure of which is incorporated herein by reference.

In order to obtain a feeling of a weightiness and a feeling of a presence with respect to a playback sound, it is indispensable to provide a high quality super low frequency (bass) or low frequency playback speaker (subwoofer or woofer). On the other hand, it can be said that it is difficult to playback a super low frequency or low frequency sound because it is difficult to prevent a harmonic distortion in a super low frequency or low frequency sound, rather than because it is difficult to reproduce lower frequency sounds. In a speaker device, since an amplitude will increase in an inverse proportion to the square of a playback frequency, it is extremely difficult to ensure, in playing back a super low frequency or low frequency sound, a linearity of a driving force in relation to a voice coil and a flux distribution of a magnetic circuit, as well as a mechanical linearity of a vibration section supporting system accompanying the amplitude.

On the other hand, it is generally known that a speaker having a smaller diameter will lead to a remarkably larger amplitude at the time of low-frequency playback (“NewEdition: Speaker &Enclosure Encyclopedia” by Tamon Saeki, Seibundo Shinkosha Publishing House, Apr. 10, 2001, p 42). Therefore, a conventional super low frequency or low frequency sound playback speaker (subwoofer or woofer) is usually designed to adopt a diaphragm having a large diameter so as to inhibit the amplitude, thereby making it possible to ensure a high quality playback.

Moreover, a diaphragm having a large diameter is required to be made of a material having a high rigidity so that when there is a large additional air weight a piston vibration can be reproduced at a large amplitude with a reduced distortion. As a result, a material suitable for use in forming a diaphragm is limited, so that there has often been in use a substrate material having certain thickness but small in density and light in weight, as well as a composite diaphragm formed by sandwiching a honeycomb cone and a foamed resin material, thereby replacing a paper cone.

However, when setting a speaker device for playing back a super low frequency or low frequency sound, it is sometimes not allowable to enlarge the diameter of a diaphragm because of an insufficient speaker setting space. Further, when it is desired to obtain a sound volume as large as possible within a predetermined space, it is preferred to dispose a plurality of relative small diameter speaker units within a predetermined space, rather than employing a speaker unit having a large diameter diaphragm, thereby making it possible to arrange sound sources with a high efficiency within the space, thus outputting a large volume sound. On the other hand, when a plurality of small diameter speaker units are used to playback a super low frequency or low frequency sound, amplitude will be increased as described above, hence rendering it impossible to effectively prevent the occurrence of a harmonic distortion.

Moreover, if, as mentioned above, a large diameter diaphragm is used to play back a low frequency sound with a high sound quality, the restriction on diaphragm material will cause an increase in the cost of a speaker unit.

### SUMMARY OF THE INVENTION

The present invention has been accomplished in order to solve the above-mentioned problem. It is an object of the present invention to reduce a playback distortion without having to increase the diameter of subwoofer or woofer, to effectively obtain a high grade sound quality even if subwoofer or woofer are disposed within a predetermined space to obtain a large volume sound, to reduce the cost of speaker unit without having to restrict the material for forming the diaphragm of subwoofer or woofer.

To achieve the foregoing objects, the speaker device of the present invention has at least the following features according to the following aspects.

According to the present invention, there is provided a speaker device comprising a speaker unit having a diaphragm disposed at an opening of a baffle plate. Specifically, a compression board is disposed opposite to a radiation surface of the diaphragm such that a predetermined interval is formed between the baffle plate and the compression board.

### BRIEF DESCRIPTION OF THE DRAWINGS

These and other objects and advantages of the present invention will become clear from the following description with reference to the accompanying drawings, wherein:

FIG. 1 is an explanatory view showing a speaker device according to an embodiment of the present invention;

FIG. 2 is an explanatory view showing a speaker device according to another embodiment of the present invention (a plurality of speaker units 1 are arranged close with each other on the baffle plate 2); and

FIGS. 3A and 3B are explanatory views showing an example of setting a speaker device according to a further embodiment of the present invention.

### DETAILED DESCRIPTION OF THE PREFERRED EMBODIMENTS

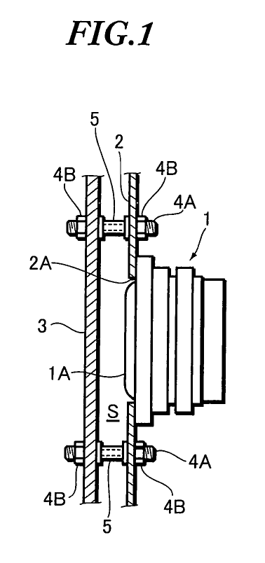

In the following, preferred embodiments of the present invention will be described with reference to the accompanying drawings. FIG. 1 is an explanatory view showing a speaker device formed according to an embodiment of the present invention. As shown, the speaker device of the present invention comprises a speaker unit 1 whose diaphragm 1A is attached to an opening 2A of a baffle plate 2. A compression board 3 is disposed to face the radiation surface of the diaphragm 1A in a manner such that a predetermined interval S is formed between the baffle plate 2 and the compression board 3. Here, the compression board 3 can be made of a wood plate, provided that such a wood plate has a required strength and a desired characteristic against the sound pressure.

In more detail, the compression board 3 is fixed to the baffle plate 2 by connection elements 4A, 4B in a manner such that an interval S is maintained between the baffle plate 2 and the compression board 3 by means of spacer members 5. Making uniform the lengths of the spacer members 5 ensures that the baffle plate 2 and the compression board 3 can be arranged in parallel with each other.

Such a speaker device, by making the speaker unit 1 suitable for playing back a super low frequency or low frequency sound (serving as subwoofer or woofer) having no directivity, can provide the following advantages.

Namely, when playing back a super low frequency or low frequency sound, an air pressure emitted from the radiation surface of the diaphragm 1A will be blocked by the compression board 3 disposed opposite the radiation surface, so that an air load in front of the diaphragm 1A will rise. For this reason, there will be a load in a direction opposite to an amplitude direction when playing back a super low frequency or a low frequency sound, thus inhibiting the amplitude of the diaphragm 1A (or voice coil). In this way, it is possible to control the amplitude of the diaphragm 1A within an appropriate range even if the diameter of the diaphragm is not increased, thereby effectively preventing the occurrence of a distortion and thus outputting a playback sound having a high quality. In other words, inhibiting the amplitude of the diaphragm 1A can improve the durability of the speaker device, so that it is possible to perform a low frequency playback having an acceptable sound quality with respect to an output of a large volume sound, without causing the voice coil to move beyond an appropriate range (a linear range of driving force) of the magnetic circuit. Moreover, it is possible to prevent a noise and a mechanical damage which might be caused by the voice coil moving beyond the appropriate range of the magnetic circuit when outputting a large volume sound.

Furthermore, by providing the compression board 3 in front of the baffle plate 2, the volume of air in front of the diaphragm 1A is decreased, so that when a super low frequency or low frequency sound is reproduced, an amount of air in front of the diaphragm 1A will uniformly become dense, thus increasing a combination impedance between the diaphragm 1A and air, thereby improving an efficiency of conversion into a sound pressure. In this way, even a small amplitude can increase the level of the sound pressure, thereby outputting a large volume sound.

In order to ensure the above-discussed advantages, the interval S between the baffle plate 2 and the compression board 3 is preferably within a sufficiently narrow range as compared with the wavelength of the playback frequency of the speaker unit 1. For example, the interval S is set at 75 mm with respect to a playback frequency of 58 Hz (wavelength λ=6 m). In this way, it is possible to ensure a remarkable increase in an air load, thereby effectively inhibiting the amplitude and obtaining a high sound pressure level by virtue of an increased air density within the interval S.

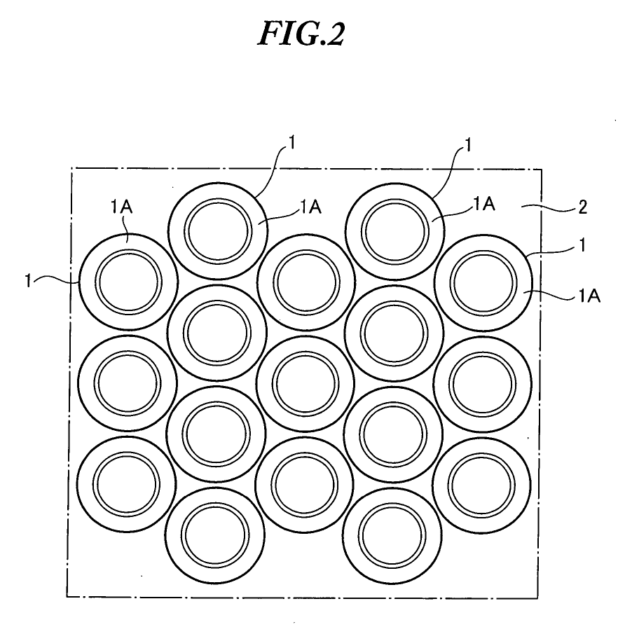

Furthermore, in case where the above-described speaker device is used to output a large volume sound within a predetermined space, the diameter of the speaker unit 1 is reduced to some extent, so that a plurality of speaker units 1 can be arranged close with each other on the baffle plate 2, as shown in FIG. 2. On the assumption that each speaker unit is a circular one, it is small diameter speaker units, rather than large diameter speaker units, that can be arranged within a predetermined space at a high density, so that it is possible to increase an area occupied by sound sources within the space, thereby making the speaker device effective in outputting a large volume sound.

In this way, by disposing the compression board 3 in front of the diaphragm 1A in a manner such that the diaphragm 1A is entirely covered up, it is possible to inhibit the amplitude of the diaphragm 1A even if the speaker units 1 are all small in their diameter, thereby making it possible to playback a super low frequency or low frequency sound without any distortion. Further, as described above, since an increase in the combining impedance between the diaphragm 1A and air can cause an increase in an efficiency of conversion into sound pressure, it is possible to increase a sound pressure level even if the forgoing amplitude is small. Therefore, it is possible to improve a playback characteristic in a low frequency band and output a low frequency sound with a large volume.

On the other hand, if a plurality of speaker units 1 are arranged without installing the compression board 3, distances between these speaker units 1 on one hand and a listening location on the other will be different from one another, so that a sound pressure loss will occur due to phase deviations among emitted sounds. If the compression board 3 is provided in a manner such that all the speaker units 1 are covered up, the emitted sounds will be at first mixed with one another between the baffle plate 2 and the compression board 3. In this way, phase deviations can be eliminated, thereby reducing the sound pressure loss.

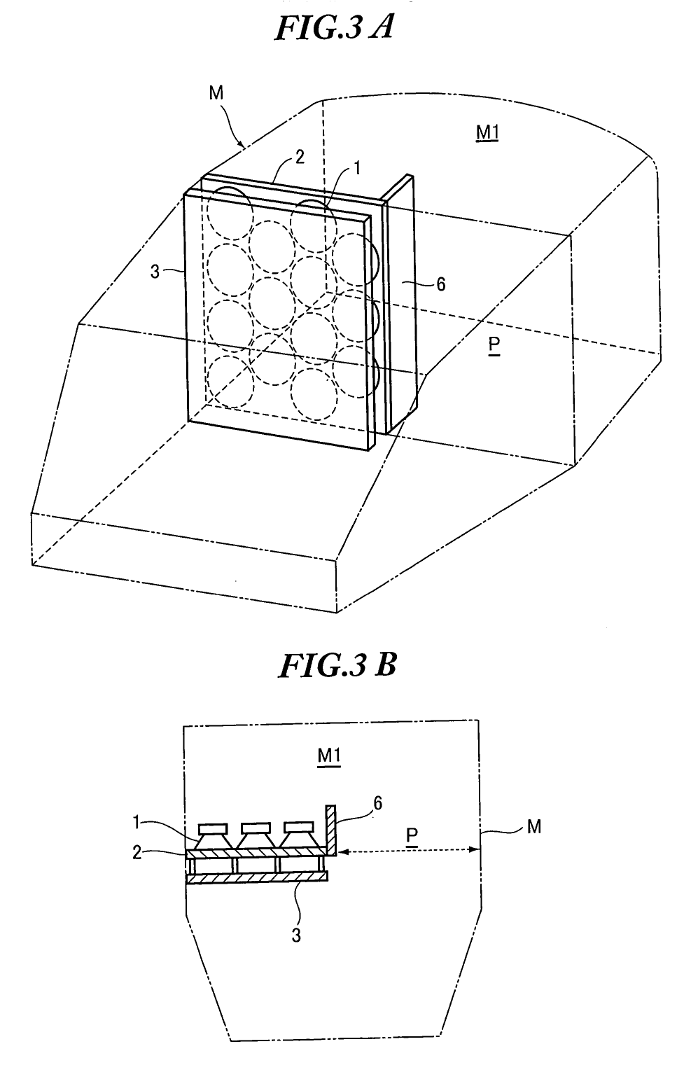

FIGS. 3A and 3B show an example of setting a speaker device according to one embodiment of the present invention. In more detail, FIG. 3A is a perspective view showing an internal space M within a vehicle and FIG. 3B is a plan view illustrating an arrangement shown in FIG. 3A. In fact, FIGS. 3A and 3B show a vehicle speaker system in which a speaker device is set within a vehicle such as a track by virtue of a vehicle internal space M. As shown, a compression board 3 and a baffle plate 2 are set behind a passenger seat or a driver's seat. Further, a duct plate 6 is provided which is extending from one end of the baffle plate 2 to the rear side of the space M (such as luggage platform). At this time, a rear space M1 is used as a speaker cabinet, while an opening area P (refer to FIG. 3) on one side adjacent to the speaker device (the speaker units 1, the baffle plate 2, and the compression board 3) containing the duct plate 6 functions as a port, thereby forming a bass reflex type speaker device having a port based on the opening area P according to the present embodiment. On the other hand, it is also possible to form a compression board 3 by partially using the back surface of a seat and equipment within the vehicle, instead of specifically providing such a compression board 3. In this way, according to the present embodiment, it is possible to play back a super low frequency or low frequency sound with a large volume.

Moreover, according to the present embodiment, if the size of the compression board 3 is made slightly smaller than the baffle plate 2, it is possible to emit a sound in a manner such that the compression board 3 is covered up in four directions (upper, lower, left and right). Alternatively, if the size of the compression board 3 is made the same as or larger than the baffle plate 2, it is possible to set the side space on the driver seat or passenger seat so that it acts as a playback sound radiation area.

As discussed above, according to the speaker device of the above-described embodiments of the present invention, it is allowed to obtain the following advantages. Firstly, it is possible to reduce a playback distortion without having to increase the diameter of speakers (subwoofers or woofers). Secondly, it is possible to effectively obtain a high quality sound having a reduced distortion, even if subwoofers or woofers are arranged close with each other in a predetermined space to obtain a large volume sound. Thirdly, since the diaphragm 1A is not enlarged in its diameter, it is not necessary to restrict a material for forming a diaphragm, thereby making it possible to reduce the cost of each speaker unit. Fourthly, by providing the compression board 3 in front of the baffle plate 2, the air in front of the diaphragm 1A will have a uniformly high density when playing back a super low frequency or low frequency sound. Meanwhile, since a combining impedance between the diaphragm 1A and the air will rise and thus an efficiency of conversion into a sound pressure will be increased, it is possible to raise a sound pressure level even if the forgoing amplitude is small, thereby outputting a large volume sound.

While there has been described what are at present considered to be preferred embodiments of the present invention, it will be understood that various modifications may be made thereto, and it is intended that the appended claims cover all such modifications as fall within the true spirit and scope of the invention.

1. A speaker device comprising a speaker unit having a diaphragm disposed at an opening of a baffle plate,
wherein a compression board is disposed opposite to a radiation surface of the diaphragm such that a predetermined interval is formed between the baffle plate and the compression board.

2. The speaker device according to claim 1, wherein the speaker unit is used for playing back a super low frequency or low frequency sound.

3. The speaker device according to claim 1, wherein said interval between the baffle plate and the compression board is a sufficiently narrow interval as compared with the wavelength of the sound wave of the playback frequency of the speaker unit.

4. The speaker device according to claim 1, wherein a plurality of said speaker units are arranged close with each other on the baffle plate.

5. The speaker device according to claim 1, wherein a playback sound radiation area is formed on one side of an interval between the baffle plate and the compression board.

6. The speaker device according to claim 2, wherein said interval between the baffle plate and the compression board is a sufficiently narrow interval as compared with the wavelength of the sound wave of the playback frequency of the speaker unit.

7. The speaker device according to claim 2, wherein a plurality of said speaker units are arranged close with each other on the baffle plate.

8. The speaker device according to claim 3, wherein a plurality of said speaker units are arranged close with each other on the baffle plate.

9. The speaker device according to claim 6, wherein a plurality of said speaker units are arranged close with each other on the baffle plate.

10. The speaker device according to claim 2, wherein a playback sound radiation area is formed on one side of an interval between the baffle plate and the compression board.

11. The speaker device according to claim 3, wherein a playback sound radiation area is formed on one side of an interval between the baffle plate and the compression board.

12. The speaker device according to claim 6, wherein a playback sound radiation area is formed on one side of an interval between the baffle plate and the compression board.

13. The speaker device according to claim 4, wherein a playback sound radiation area is formed on one side of an interval between the baffle plate and the compression board.

14. The speaker device according to claim 7, wherein a playback sound radiation area is formed on one side of an interval between the baffle plate and the compression board.

15. The speaker device according to claim 8, wherein a playback sound radiation area is formed on one side of an interval between the baffle plate and the compression board.

16. The speaker device according to claim 9, wherein a playback sound radiation area is formed on one side of an interval between the baffle plate and the compression board.
